(19) United States
(12) Patent Application Publication
(10) Pub. No.: US 2008/0300872 A1
(43) Pub. Date: Dec. 4, 2008

(54) SCALABLE SUMMARIES OF AUDIO OR VISUAL CONTENT

(75) Inventors: Sumit Basu, Seattle, WA (US); Surabhi Gupta, Stanford, CA (US); John C. Platt, Bellevue, WA (US); Patrick Nguyen, Seattle, WA (US); Milind V. Mahajan, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/756,059

(22) Filed: May 31, 2007

(51) Int. Cl. G10L 15/26

(52) U.S. Cl. 704/235; 704/E15.043

(57) ABSTRACT

Providing for browsing a summary of content formed of keywords that can scale to a user-defined level of detail is disclosed herein. Components of a system can include a summarization component that extracts keywords related to the content and associates the keywords with portions thereof, and a zooming component that displays a number of keywords based on a keyword/keyphrase relevance rank and a zoom factor. Additionally, a speech to text component can translate speech associated with the content into text, wherein the keywords are extracted from the translated text. Consequently, the claimed subject matter can present a variable hierarchy of keywords to form a scalable summary of such recorded content.

### BACKGROUND

Facilitating review of recorded media information has become a popular application. Several professions require summarization and review of recorded media, such as auditory content, including, e.g., speech, monologues, dialogues, or spoken conversations, musical works, and video content, including, e.g., live or simulated visual events. For instance, physicians, psychiatrists and psychologists often record patient interviews to preserve information for later reference and to evaluate patient progress. Patent attorneys typically record inventor interviews so as to facilitate review of a disclosed invention while subsequently drafting a patent application. Broadcast news media is often recorded and reviewed to search for and filter conversations related to particular topics of interest. More generally, along with a capability to record large quantities of distributed media, a need has arisen for review and filtering of recorded media information.

Summarization can refer broadly to a shorter, more condensed version of some original set of information, which can preserve some meaning and context associated with the original set of information. Summaries of some types of information can be more challenging than other types of information. For example, spoken conversations can be difficult to summarize due to a use of disfluencies, repetition sounds, and filler sounds (e.g., sounds such as “um”, and the like, typically used as a placeholder while a speaker is formulating thoughts regarding a next item of discussion).

Typically, much information exchanged in such meetings is lost; while individuals can take notes using pen and paper, vast quantities of detail can be lost shortly after a meeting. Recording information from a meeting, whether face-to-face or over a remote communication platform (e.g., telephone, computer network, etc.) can be a valuable mechanism for preserving such information. However, difficulties arise in regard to recordings as well, typically related to review of information. For example, scanning through hours of media recordings can take an amount of time commensurate with capturing the recording in the first place. Consequently, summaries that provide facilitated review of information can enhance efficiencies associated with such review.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in various aspects thereof, provides for generating or browsing a summary of content formed of keywords that can scale to a user-defined level of detail. Components of a system can include a summarization component that extracts keywords related to the content and associates the keywords with portions thereof, and a zooming component that displays a number of keywords based on a keyphrase relevance rank and a zoom factor. More specifically, content as described herein can refer to any suitable auditory and/or visual media that can be described or otherwise associated with text-based keywords. Additionally, a system as disclosed can include a speech to text component that translates speech associated with the audio and/or visual content into text, wherein the keywords are extracted from the translated text. The audio and/or visual content can include recordings of news media, spoken conversations, or combined video and audio presentations such as movies, plays, audio/video news recordings, and the like. Furthermore, a reviewer can dynamically configure zoom factor to increase and decrease a number of displayed keywords, thereby providing a quick overview, a full transcript, or dynamically adjustable variations there between. Thus, the claimed subject matter can present a variable hierarchy, structured on relevance ranked keywords, to form a scalable summary of recorded content.

In accordance with further aspects of the claimed subject matter, a scalable summary of recorded content is provided as a function of topic and sequential occurrence. A topic presentation component can identify one or more topics (e.g., a topic of speech, a topic of a conversation or of discussion etc.) of recorded content and arrange extracted keywords into groups that relate to the identified topic(s). A sequential display component can further organize a display of keywords in a manner that is relevant to the time in which such keywords occur within content. In such a manner, a reviewer can follow a summary of keywords in an order of occurrence and as a function of topic. Consequently, a scalable summary of content can be arranged in a manner that visually conveys a context and meaning associated with such content.

In accordance with further aspects of the claimed subject matter, a scalable summary system can interface with an external application to provide scalable summaries of audio and/or visual content in a context appropriate for a particular application. For example, a lecture reviewing application can modify a display of keywords presented as part of a scalable summary, so as to provide a summary applicable to review of a professor's classroom lecture. By setting a zoom factor (e.g., by scrolling a mouse button) a student could focus into portions of the summary to display more keywords, and consequently more detail, related to a particular topic of lecture. Alternately, the student could reverse the zoom factor to provide an overview of a larger portion of the lecture.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 depicts a block diagram of an exemplary high-level system providing a scalable summary of audio and/or video content in accord with aspects of the claimed subject matter.

FIG. 2 illustrates a block diagram of an example system that can associate portions of a scalable summary with portions of recorded media represented by the summary in accord with aspects disclosed herein.

FIG. 3 illustrates a block diagram of an exemplary system that can play recorded content as a result of interaction with a scalable summary of such content in accord with aspects disclosed herein.

FIG. 4 depicts a block diagram of an example system that provides context and meaning for a scalable summary via grouping keywords according to topic of speech and sequential occurrence in accord with further aspects of the claimed subject matter.

FIG. 5 illustrates a block diagram of an example system wherein a context component provides additional context for a scalable summary in accordance with aspects of the claimed subject matter.

FIG. 6 depicts an example system that provides scalable summaries of audio and/or video content in accord with aspects of the subject innovation.

FIG. 7 illustrates a block diagram of an example system that can modify a scalable summary of recorded content to meet specifications of an external application in accord with various aspects disclosed herein.

FIG. 8 depicts an exemplary methodology for providing scalable summaries of content in accord with aspects of the subject invention.

FIG. 9 illustrates a sample methodology for presenting a variable number of keywords associated with translated media that provide a scalable summary of such media in accord with aspects disclosed herein.

FIG. 10 depicts a sample methodology for providing scalable summary of spoken conversation in accord with aspects of the claimed subject matter.

FIG. 11 illustrates a sample methodology for providing scalable summaries of spoken conversations based on topics and turns of conversation in accord with aspects disclosed herein.

FIG. 12 illustrates a sample computing environment for presenting a computer-based summary of recorded media in accordance with aspects of the claimed subject matter.

FIG. 13 depicts a sample networking environment for interacting with a remote data store and recorded content in accordance with aspects of the subject disclosure.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As will be described in greater detail below, various embodiments provide for extracting keywords from content (e.g., video, audio, speech, text, etc.), and such extracted keywords are relevance ranked. A summarization hierarchy is generated as a function of the relevance ranked keywords that maps to the associated content. The summarization hierarchy facilitates navigating through varying levels of summarization detail associated with the content. Accordingly, a user can employ the hierarchy to quickly access coarse as well as fine levels of summarization detail. Moreover, the hierarchy can be mapped to the content via multiple dimensions of interest (e.g., temporal, personal preferences, images, particular individual, type of information, relevancy to user state or context of an event, etc.). Accordingly, the embodiments described herein provide for analyzing content and efficiently generating a useful and accurate summarization of the content that allows for zooming in and out (spanning across) varying levels of desired summarization detail as well as navigating to desired sections of the content quickly.

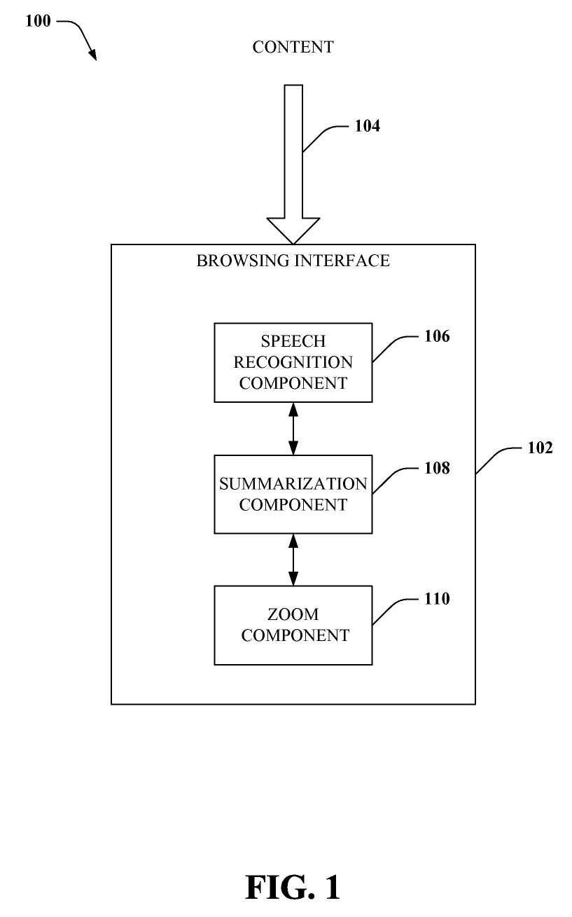

Referring to FIG. 1, a block diagram is depicted of an exemplary high-level system 100 that provides a scalable summary of audio and/or video content in accord with aspects of the claimed subject matter. Browsing interface 102 can provide a dynamically adjustable hierarchy of information related to audio and/or video content 104. Browsing interface 102 can include a computing device, such as a personal computer (PC), personal digital assistant (PDA), laptop computer, hand-held computer, mobile communication device, or similar computing device, a computer program or application that can run on a computing device, or electronic logical components and/or processes, or like devices and/or processes, or combinations thereof. Additionally, browsing interface 102 can also include a display device capable of graphically rendering the information related to audio and/or video content.

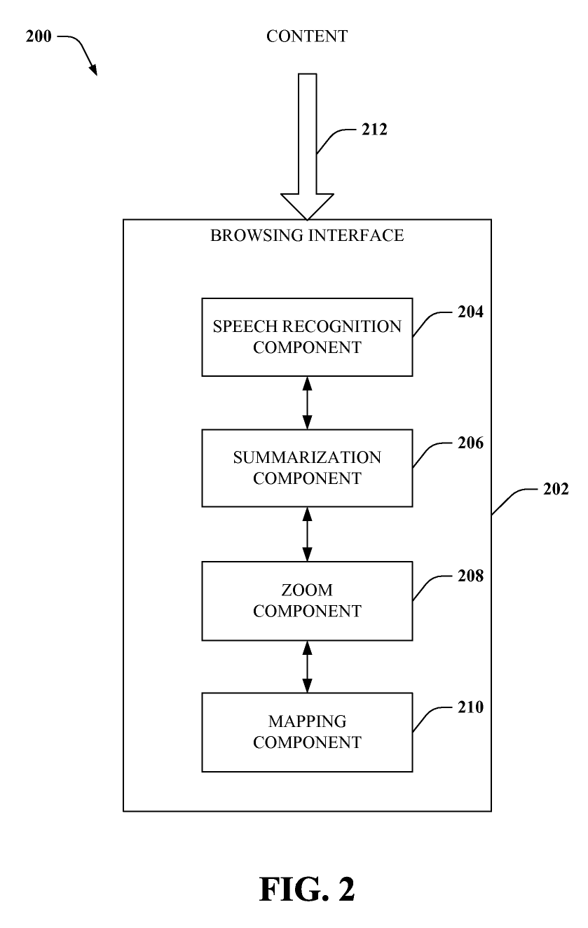

Browsing interface 102 enables a viewer to quickly review and find information related to content 104. Browsing interface 102 can render different colors, fonts, markers (e.g., lines, visual flags etc.), and the like to distinguish groups of information related to a portion of content 104, and/or a topic of conversation (see FIG. 2, infra). Browsing interface 102 can further include any suitable user interface control that can enable functionality disclosed herein, such as zooming controls to indicate a user-defined zoom factor (discussed in greater detail below), play back controls (e.g., volume, play speed, indication of position in a recording, etc.) associated with content, scroll bars to display sequences of text, and like application user interface controls. In addition, browsing interface 102 can provide a timeline to indicate a relative time of occurrence of text within a larger document, recording, speech, or the like. Utilizing scroll bars to display sequences of text can effectively enable a viewer to scroll forward and backward in time as related to text displayed by browsing interface 102. Such scrolling can occur, for instance, by a rotating a wheel of a mouse, clicking and dragging a mouse on the displayed text, using a scroll bar, targeting and activating scroll keys on browsing interface 102, and like user interface controls.

Content 104 can include any suitable auditory and/or visual information that includes or can be associated with a speech, text, and/or conversation based description or document (e.g., described by text, or speech, or discussed in conversation, etc. such that aspects of the audio and/or video information can be distinguished from other aspects and articulated via such speech, text, and/or conversation; examples could include closed caption text information broadcast with news, played with movies, etc.) Examples include spoken conversations, news media, movies, television shows, plays, books, magazines, lectures, discussions, meetings, or the like. Additionally, such information can be captured live (e.g., by a component of browser interface 102), recorded (e.g., as an audio and/or video .wav, mp3, or similar file), distributed (e.g., via radio, public and/or private communication network such as the Internet or an intranet, a local area network, wide area network, or like network, by television, satellite, publication, computer readable media, electronically readable media, and like mechanisms) or both.

Speech recognition component 106 can translate speech into text. More specifically, speech, as indicated herein, can be identified in one or more of various languages and can be translated to text in the same or substantially similar language, or into one or more different languages. Additionally, such text can be presented in a language according to one or more of various alphabets. Also, speech recognition component 106 can utilize typical methods for identifying and parsing words from vocal sounds (e.g., similar to systems trained and/or calibrated on phone switchboard data). Speech recognition component 106 can receive speech incorporated within content 104 or separate from, and related to, content 104 (or, for instance, portions thereof). For example, such speech can be a suitable live, recorded, and/or distributed commentary, discussion, lecture, etc., associated with content 104, though the speech is not originally a part of content 104.

Summarization component 108 can receive text related to, descriptive of, and/or extracted from content 104, (e.g., from speech recognition component 106, or from a text file, document, or the like related to content 104 and input into browsing interface 102 and/or input into storage media (not shown) accessible by browsing interface 102 or components thereof) extract a plurality of keywords related to such text (e.g., text translated from speech by speech recognition component 106, or speech and/or text incorporated within content 104) and associate one or more of the plurality of keywords with at least a portion of content 104 related to the speech (e.g., one or more keywords can be mapped and/or linked to a portion of content 104). In addition, summarization component 108 can create a summarization hierarchy of content 104 by presenting dynamically adjustable portions of the extracted keywords at browsing interface 102.

Keywords can be identified based upon a weight value given to a term (e.g., a term can include a word, such as a unigram, or portion thereof, a phrase, such as a sequence of two words, or bigram, or the like). For example, the term frequency times inverse document frequency (TFIDF) measure that is commonly used in information retrieval can be used to provide a weight of all terms received by summarization component 108. Term frequency (TF) can be a measure of importance of a term (e.g., word, phrase, etc.) as used in a description or document. For example, term frequency can be calculated by the following equation:

TF=n/N

where n is an integer representing the number of times a term appears in a description (e.g., speech, text, and/or conversation based description, etc.) and N is the total number of words in the description. Inverse Document Frequency (IDF) can be a measure of how often a term occurs in documents in general, and can be computed from a large standard corpus like the Fisher Corpus, or, more generically, conversational speech, for instance. More specifically, the Inverse Document Frequency can be calculated by the following equation:

IDF=log(D/DT)

where D is the total number of documents in the corpus (e.g., the Fisher Corpus, conversational speech), and DT is the number of documents containing the term. The TFIDF measure can then be expressed as the product of the following terms:

TFIDF=TF*IDF

System 100 can additionally create a keyword relevance rank (or, e.g., keyphrase relevance rank, the keyphrase containing multiple words or portions of words) for each of the plurality of keywords related to content 104, such that numbers of keywords can be displayed relative to their keyword relevance rank and a zoom factor (e.g., in descending order of keyword relevance rank). The keyword relevance rank can be constructed from various qualifiers and/or quantifiers that indicate representation of, relatedness to or affiliation with content 104. For example, non-verbal cues (e.g., pauses, prosody, loudness of voice, etc.), speaker turn information (e.g., conversation/meeting non-textual context, see also topic segmentation component 408 discussed infra), visual cues, textual content or TFIDF measure, or combinations thereof, can be utilized to compute the keyword relevance rank for extracted keywords (e.g., by the summarization component 108). For bigrams and other multi-word terms (e.g., phrases), the TFIDF measure can be found in a substantially similar way to that of a single word term, except that for a multi-word term TF can refer instead to a number of occurrences of the multi-word term in a document, and DT can refer instead to a number of occurrences of the multi-word term in a corpus. Because the frequency of occurrence of bigrams in the corpus may not be readily available (e.g., if only the IDF values are available and not the original corpus), a probability of occurrence of a bigram in the corpus can be approximated by a product of the probabilities of occurrence of component terms of the bigram (assuming the component terms occur independently of each other within the corpus). Consequently, the TFIDF of a bigram (e.g., a sequence of two words) can be approximated as follows:

TFIDF(bigram)≅TFIDF1*TFIDF2=(TF)*(IDF1+IDF2)

where TF is the frequency of the bigram in the document, and IDF1 represents the IDF of the first unigram in the bigram, and IDF2 represents the IDF of the second unigram in the bigram. More generically, the IDF for a Z-word term can be extrapolated as follows:

$$\begin{matrix}IDF ( Z - word term ) = log ( D 1 / DT 1 * D 2 / DT 2 * … * DZ / DTZ ) \\ = IDF 1 + IDF 2 + … + IDFZ\end{matrix}$$

Where IDFZ is the IDF, as described supra, of the Z^{th} word of a multi-word term, where Z is an integer.

In accord with additional aspects of the claimed subject matter, a relevance measure of bigrams and unigrams can be normalized so that both unigram and bigram key words/phrases can appear at the top of a ranked list of keywords (e.g., that is used to form a summarization hierarchy having dynamically adjustable levels of detail, as described herein). Such normalization can be effectuated by separately ranking relevance measure scores of the unigrams and bigrams and then computing a multiplicative factor that can modify the score of a top ranked bigram to be substantially equivalent with the score of a top ranked unigram. Additionally, since relevance measures of multiple bigrams can be more disperse as compared with relevance measures of multiple unigrams, a square root of bigram relevance measures (e.g., TFIDF scores) can be taken. The square root of the bigram relevance measures can create a list of adjusted bigram scores that promote an even mixture of unigrams and bigrams at the top of the ranked list of keywords (or, e.g., key-phrases). More specifically, the adjusted bigram score can be provided by the following formula:

Adjusted Bigram Score=SQRT[TFIDF(bigram)]*ALPHA

where

ALPHA=MAX_UNIGRAM_TFIDF/MAX_BIGRAM_TFIDF

and where MAX_UNIGRAM_TFIDF and MAX_BIGRAM_TFIDF are the maximum TFIDF scores for the unigrams and bigrams respectively.

Other suitable embodiments can exist for scoring words and phrases in terms of their relevance to content 104 and/or portions thereof. For instance, a mutual information measure can be used to measure information gained from the presence of a word or phrase within a particular document vs. the presence of a word or phrase in a corpus. Also, individuals or system components can manually rank keywords and/or portions of content according to an ad hoc ranking structure. The subject specification is therefore not limited to the particular embodiments articulated herein. Rather, any suitable embodiment for scoring relevance of words and phrases, known in the art or made known to one of skill in the art by way of the context provided by the examples articulated herein, is incorporated into the subject disclosure.

In such a manner, the keyword relevance rank associated with multi-word terms can be normalized with respect to the keyword relevance rank associated with single word terms. Consequently, summarization component 108 can extract single or multi-word terms from a description document (e.g., translated text, speech, discussion, etc.) associated with content 104 and calculate a TFIDF weighting score associated with a keyword. Subsequently, summarization component 108 can normalize the TFIDF scores to create a keyword relevance rank associated with each keyword. Keywords can be presented in an order according to their keyword relevance rank, up to a threshold relevance rank related to an amount of presentable space (e.g., a render-able area on a display of browsing interface 102) and a contemporaneous amount of space filled by presented keywords.

System 100 can further present a varying number of keywords to create dynamically versatile levels of detail associated with content 104. Zoom component 110 can display each of a plurality of keywords (e.g., identified by summarization component 108) based on a keyword relevance rank and a zoom factor. Also, zoom component 110 can adjust the presentation (e.g., by summarization component 108) of portions of the extracted keywords based on the keyword relevance rank and the zoom factor, to reveal different levels of detail with respect to content 104. More specifically, the zoom factor can be related to a keyword threshold and/or an amount of presentable space associated with browsing interface 102. The keyword threshold can establish a cut-off for presenting or hiding keywords based on a relevance rank associated with each keyword. The amount of presentable space can include space available for rendering keywords (e.g., amount of area on a display or monitor, in an application window, etc.).

The zoom factor, as described in relation to system 100 and in addition to the above, can control a density, number, font size, etc., associated with the presentation of keywords within browsing interface 102; changes in the zoom factor can increase and decrease a number of keywords displayed within a particular presentable space. Consequently, changing zoom factor values can lower and increase the keyword threshold, causing fewer or more keywords to be rendered, up to a number of keywords that will fit within an available presentation space. Optionally, quantities such as keyword font size, keyword spacing, presentable area size (e.g., for an application window or similar adjustable presentation area) and like factors can be adjusted, automatically or manually, to facilitate presentation of a scalable summary as described herein.

The zoom factor associated with zoom component 108 can be a user-defined quantitative (e.g., a sliding scale of increasing and decreasing numbers) or qualitative (e.g., descriptive details such as more specific detail, more overview information, or like descriptors) entity, increased and decreased by a reviewer. For example, a keyword can be presented on browsing interface 102 as a function of relevance rank and a presentation threshold. Furthermore, the presentation threshold can be a function of presentable space available on browsing interface 102, and a zoom factor level. Keywords with relevance ranks higher than the presentation threshold can be presented, whereas keywords with relevance ranks lower than the presentation threshold can be hidden. By changing the zoom factor along a sliding scale, a user can transition between an overview state in which only a few keywords having high relevance ranks are presented, to a descriptive state where many keywords or all keywords (e.g., representing most or all of a description/document) are presented, and various levels in-between.

Referring now to FIG. 2, a system 200 is depicted that can present and map a scalable summary of content 212 to recorded portions thereof in accord with aspects disclosed herein. Browsing interface 202 can present an adjustable hierarchy of keywords associated with content 212, enabling a continuous variation of the level of detail associated with a summary of such content, allowing a broad overview or a detailed investigation, or any suitable degree in between. Content 212 can include any suitable auditory and/or visual information that contains or can be associated with a description and/or document capable of being reduced to text (e.g., a speech, text-based description or discussion, and/or a conversation that can be translated to text, etc., such that aspects of the auditory and/or visual information can be distinguished from other aspects and articulated via such speech, text, and/or discussion).

Speech recognition component 204 can receive, parse, and/or translate speech (e.g., spoken conversations, dialogues, monologues, multiple participant conversations, and the like) into text. Furthermore, such speech can be in any suitable language or dialect, and such text can be in the same or different languages or dialects as compared to the speech, utilizing one or more suitable alphabets. Summarization component 206 can receive text (e.g., from speech recognition component 204, from content 212, etc.), extract one or more informative words and/or phrases from such text and calculate a keyphrase relevance rank for each extracted word and/or phrase. Such relevance rank can be based on a TFIDF score, substantially similar to that described supra, and/or an adjusted TFIDF score. More specifically, the adjusted TFIDF score can normalize a likelihood of occurrence of multi-word terms versus single word terms. Subsequently, summarization component 206 can create a single, sorted list of keyword terms and associated keyphrase relevance ranks (or, for instance, adjusted keyphrase relevance ranks).

Zoom component 208 can present each of a plurality of keywords according to a keyphrase relevance rank and a zoom factor. The zoom factor can establish a zoom threshold level based in part on, for example, an available presentation space, or a user-defined or automatically determined scale setting, or similar mechanisms, or combinations thereof. Zoom component 208 can compare a keyphrase relevance rank of each keyword to the zoom threshold, and present keywords with a relevance rank higher than the threshold (e.g., at browsing interface 202), and hide keywords with a relevance rank lower than the threshold. By dynamically changing the scale setting a varying hierarchy of keywords, providing more or less detail associated with content 212 or portions thereof, can be presented to a viewer. Such a varying hierarchy of keywords can enable real-time control of an amount and detail of information related to summarized content.

Additionally, system 200 can include a mapping component 210 that can associate a scalable summary of content (e.g., content 212) with a recording of at least a portion of such content and/or description of such content (see supra). Such association can be, for example, between a keyword and a portion of the content and/or description. For example, a keyword can represent a link (e.g., hyperlink, etc.) to a segment of content and/or description of such content where a keyword occurs. By clicking the link, a user can access a recording of content 212 or description thereof. Therefore, system 200 can provide a dynamically changeable summary of content where portions of the summary itself can be used to access corresponding portions of a recording of the content.

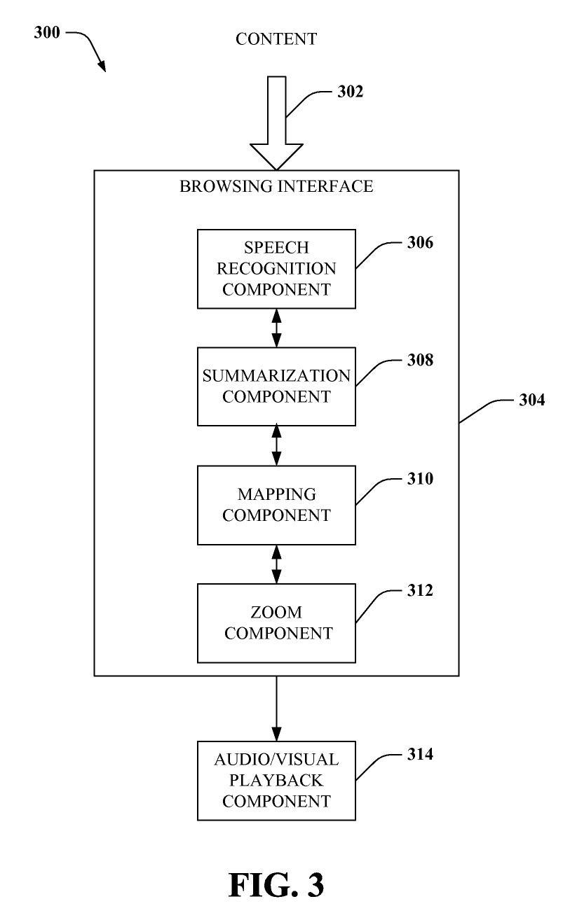

FIG. 3 depicts a system 300 that provides a dynamically variable digest of information related to content 302, wherein portions of such digest can initiate access and playback of recorded segments of the content 302. Browsing interface 304 can present an adjustable structure of keywords, providing information related to content 302, to form a summary thereof. Such structure can organize keywords as a function of available display space of a device or application, according to a timeline of occurrence within content 302 or a description thereof, as a function of topic, as a function of a speaker or writer, of speaker turn, or like classifier suitable to parse an audio and/or video media file and/or description thereof. Speech recognition component 306 can receive, parse, and translate speech, in one or more languages, into text in the same and/or different languages. Summarization component 308 can receive text and extract one or more informative words and/or phrases and associate a keyphrase relevance rank thereto.

Mapping component 310 can associate a scalable digest of information with portions of the original content and/or description thereof. For example, portions of the digest, such as an individual keyword or group(s) of keywords, can form a link to a recording of a related portion of content 302 and/or description thereof. Such recording can then be played on an audio/visual playback component 314 associated with browsing interface 304. Zoom component 312 can present a plurality of keywords to form a scalable digest of information representing a detailed description of portions of content 302, a brief overview thereof, or various levels in between, as described supra.

As a more specific example related to a summary and an audio/video recording, a particular audio/video clip of a safari hunt can illustrate an animal, such as a lion, attacking prey. A commentator could, for example, be discussing the action as it is occurring and captured by a video camera. Subsequently, an audio/video file containing the recording can be provided to browsing interface 304, wherein speech recognition components (e.g., 306) can parse and translate spoken commentary into text. Keywords from such text can be created and displayed as a hierarchical summary of the video/audio content (e.g., by summarization component 308). Additionally, a viewer reviewing the summary could click on and/or select a keyword link, associated for instance with the lion, and related portions of content 302 or a verbal description thereof can be sent to audio/visual playback component 314. Subsequently, the original audio/video file can be played to the viewer, beginning at a point where the commentator began speaking about the lion. Audio/visual playback component 314 can further access an entire recording associated with content 302, allowing a viewer to scroll to and play portions prior or subsequent to the lion segment, or any other portion of content 302. Additionally, standard user interface and playback mechanisms associated with computer-based and electronic component based audio/visual playback applications can be included within audio/visual playback component 314 (e.g., fast forward, rewind, increased speed playback, skipping to portions of a recording for playback, volume control, chapter selection, etc.)

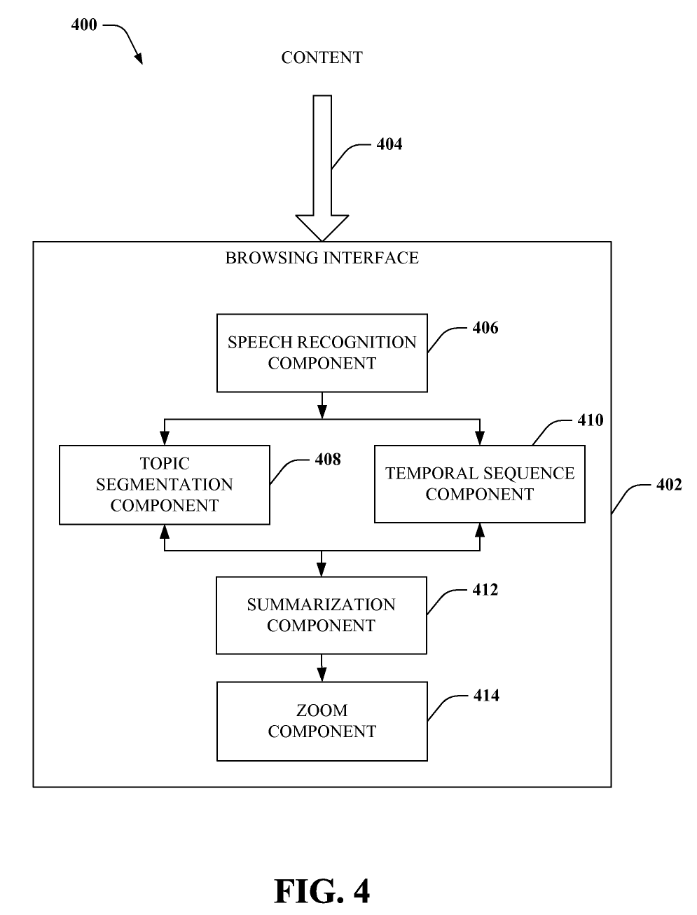

FIG. 4 depicts an exemplary system 400 that provides segmentation of a summary into topic of discussion and sequential occurrence of keywords in accord with aspects of the claimed subject matter. More specifically, system 400 can group keywords presented as part of a browsing interface 402 as a function of topic of discussion and sequential order of occurrence associated with content 404. Speech recognition component 406 can receive, parse, and translate audio information associated with or descriptive of content 404 into text (e.g., as described above at 106 of FIG. 1).

Topic segmentation component 408 can divide content 404 and/or descriptions thereof (supra) into sub-categories according to topics of discussion. Any point within content and/or a discussion can be given a probability of being a topic boundary based on a log-linear model trained on topic detection and tracking (TDT) data (e.g., a broadcast news corpus) using word distribution features and particular keywords. Additional factors for identification of topic boundaries can occur through acoustic cues such as pauses in conversation or discussion, textual features within a conversation, etc. Furthermore, heuristic constraints can be utilized to remove content segments considered to short to be topic boundaries. Such a constraint can be established via a topic duration threshold, which can be constant, user-specified, or automatically determined.

Identified topics can be distinguished from other topics via browsing interface 402. For example, a colored segment of display can indicate keywords associated with a particular topic, and a segment of display of a different color can indicate keywords associated with a second topic. Viewers can therefore scan an overview of keywords associated with one or more topics to quickly obtain basic information about a topic and a discussion related thereto. In regard to the previous example provided in FIG. 3, a video related to a safari hunt can have a particular topic related to content depicting a lion hunting prey along with a commentator's discussion of such events. Keywords extracted from this portion of content can be displayed by browsing interface with one particular background color, font color, etc., set off from other topics via lines or like boundaries, or substantially similar mechanisms for distinguishing one group of keywords from another group of keywords.

System 400 can also include a temporal sequence component 410 that structures display of one or more of the plurality of keywords according to a temporal occurrence of such keywords within received text or content 404. More specifically, temporal sequence component 410 can parse content 404 or related information to establish a timeline of content associated therewith. Such a timeline can, for instance, be displayed within browsing interface 402 to indicate duration of a document, and sequence information associated with portions of a scalable summary. For example, the beginning, duration, and end of topics of discussion presented by browsing interface 402 can be correlated to discrete points of time, displayed as a timeline along an edge of an application window, for instance. A quick visual review will provide a user with such timeline information related to topics. In addition, sequence information can be associated with extracted keywords (e.g., extracted by summarization component 412, below) to indicate a time of occurrence for each displayed keyword. For instance, keywords can be displayed relative to a timeline indicating a sequential flow of text as it occurs in content 404 or related document. Additionally, keywords can be organized as a function of occurrence within a summary presentation, where keywords appearing before and after each other are displayed in a distinct manner indicating such sequence (e.g., keywords occurring earlier in time can appear above, to the left of, etc., keywords that occur later in time). A quick visual scan of keywords as a function of timeline can indicate to a viewer a manner in which a conversation, discussion etc. progresses over time.

Summarization component 412 can receive text and extract keywords from text, associate such keywords with a keyphrase relevance rank. Additionally, keywords can be associated with a sequential time in which they occur in content, and displayed within browsing interface 402 in a manner indicating such sequence. Zoom component 414 can display a number of keywords depending on a keyphrase relevance factor as compared to a keyword threshold and an available area of presentation space, as discussed supra. In addition, zoom component can allow a user to display a number of keywords associated with a particular topic or group of topics, enabling a user to zoom in on portions of a discussion, presentation, or similar event as a function of topic of discussion. Therefore, each topic can be viewed as an overview, in specific detail, or in various levels in between. In such a manner, system 400 can present a scalable summary of audio/visual media and discussions related thereto, as a function of topic and sequence of events in order to provide additional context and meaning to keywords forming such summary.

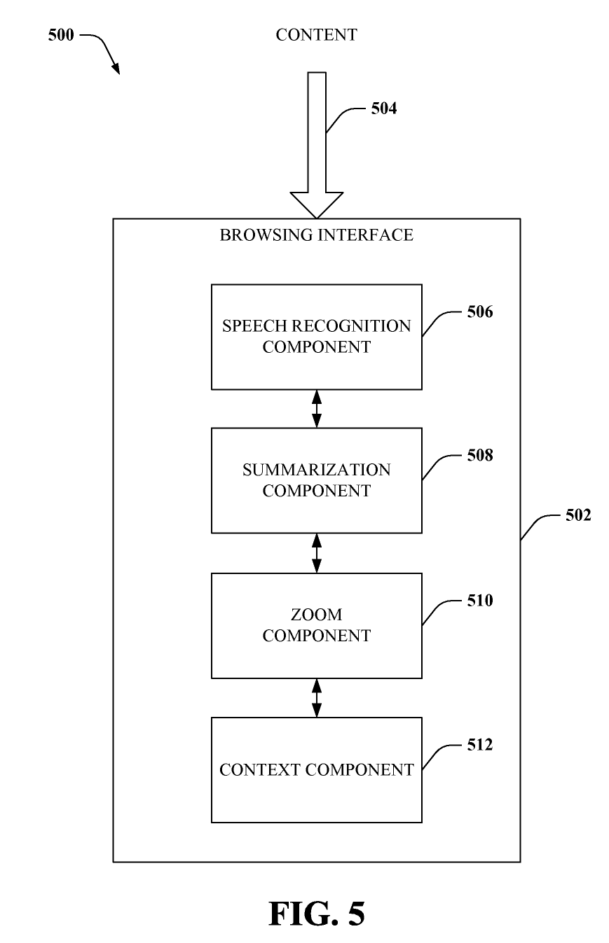

FIG. 5 depicts a system 500 that can provide additional context for a hierarchical display of keywords forming a scalable summary in accord with various aspects of the subject innovation. Browsing interface 502 can provide for a presentation of keywords related to content 504 in a manner substantially similar to that described supra. Speech recognition component 506 can receive, parse, and translate audio information associated with or descriptive of content 504 into text. Summarization component 508 can receive such text and generate keywords descriptive of content 504, and assign a keyphrase relevance rank to each keyword as described supra. Zoom component 510 can vary a number of keywords displayed via browsing interface 502 (e.g., as a function of topic of speech, sequential occurrence in a summary) relative to a keyphrase relevance rank and a zoom factor. Additionally, zoom component 510 can control a density, font size, etc. of keywords presented within an available space to modify a level of detail associated with a summary and zoom factor.

System 500 can further provide additional context to keywords presented on browsing interface 502 (e.g., as generated by summarization component 508 and populated by zoom component 510). A context component 512 can select one keyword, or a group of keywords (e.g., grouped as a function of topic, sequential time, speaker, etc.) and display a user-defined or default number of words adjacent to that keyword, as they appear in an original text and/or in a subset of content 504. For example, a user can select a group of keywords based on a topic associated with a lion hunting prey, and display the three nearest words prior to and/or subsequent to the keyword, as they appear in content 504 or a description thereof. As a more specific example, a bigram keyword “lion charges” could be populated with 2 words prior and subsequent to that bigram, as those words appear in the original content. Therefore, such a display could result in “swiftly the lion charges its prey”, to quickly give more context to the words “lion charges”.

System 500 can enable a user to control display of keywords and additional words presented in association with context component 512. For instance, a user can set a number of preceding and subsequent words to display, up to displaying all text between keywords. Additionally, browser interface 502 can adjust the font size, organization, positioning, overlap etc. of displayed words and keywords in order to render them within a specific display area. A user can further establish options for a degree of overlap, or space between rendered words, a minimum and/or maximum font size, or any other suitable display-based user interface control related to visual organization of text-based information.

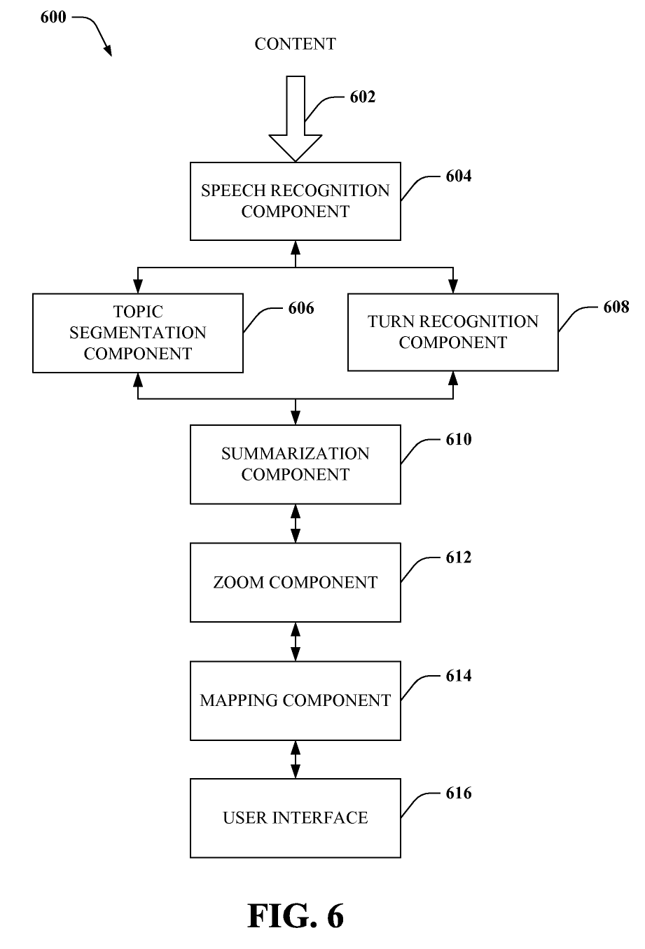

FIG. 6 illustrates a further example system 600 that provides scalable summaries of audio and/or video content in accord with aspects of the subject innovation. Content 602 can include any suitable auditory and/or visual information that includes or can be associated with a speech, text, and/or conversation based description or document (e.g., described by text, or speech, or discussed in conversation, etc. such that aspects of the audio and/or video information can be distinguished from other aspects and articulated via such speech, text, and/or conversation; examples could include closed caption text information broadcast with news, played with movies, etc.) Such content 602 can be received by a speech recognition component 604, whereby verbal portions of content 602 can be translated into text. Subsequently, text associated with content 602 (e.g., translated by speech recognition component 604, manually provided to system 600 on storage media, for instance, extracted directly from content 602, or the like) can be parsed by topic segmentation component 606 in order to identify particular topics of conversation, discussion, presentation, etc., associated with content 602.

Text (and, e.g., additional features obtained from the audio and/or video portion of content 602, such as verbal and/or auditory characteristics, fluctuations, or nuances attributable to different speakers, as well as section headings, page, sentence and/or paragraph breaks, titles, blank, heading or topic screens, or the like) can be received by a turn recognition component 608 that can determine a change from one speaker to a next, or an overlap of two or more speakers (e.g., two or more speakers speaking concurrently), and group text as a function of contiguous, interrupted sequences of one speaker or particular speakers conversing. Each contiguous interrupted sequence can be classified as one speaker turn. Additionally, text can be grouped, tagged, labeled, or similarly associated, with a particular speaker turn for further indication and presentation by a browsing interface (e.g., indicated at 502 of FIG. 5 or at user interface 616 infra). Once topic segmentation and speaker turns have been identified, text can be prepared for presentation as a scalable summary.

Summarization component 610 can generate a plurality of keywords associated with content 602 and associate a keyword rank with each keyword, as described supra. Additionally, keywords can be grouped at least in regard to a topic of conversation(s) associated with a keyword and a speaker turn(s) articulating a keyword, as described above. Zoom component 612 can display a number of keywords as a function of keyword rank and a zoom factor, such that particular topics can be selected and display of a number of keywords associated with those topics can be increased or decreased. Additionally, zoom component 612 can display larger or fewer numbers of keywords associated with particular speaker turns in order to give a user varied control of the display of information associated with content 602.

Mapping component 614 can associate one or more keywords with recorded portions of content 602. Such association can enable a user to access and play a portion (e.g., on a media player device, electronic video and/or audio playback device, etc.) the portion of content 602 related to a selected keyword. For example, a bigram “lion charges” associated with a summary of a jungle safari film can initiate playback of an audio/video recording where a commentator is discussing a lion charging prey, and/or where a video portion of the recording is depicting such events. User interface 616 can include any suitable medium that can present and/or display a text-based summary associated with content 602. Examples can include a personal computer, laptop, PDA, mobile computing device, mobile communication device, an application running on any suitable computing device, or the like. User interface can also include various examples of browsing interface 102, presented supra, providing a user with controls over display, presentation and organization of a scalable summary of content 602, as described herein.

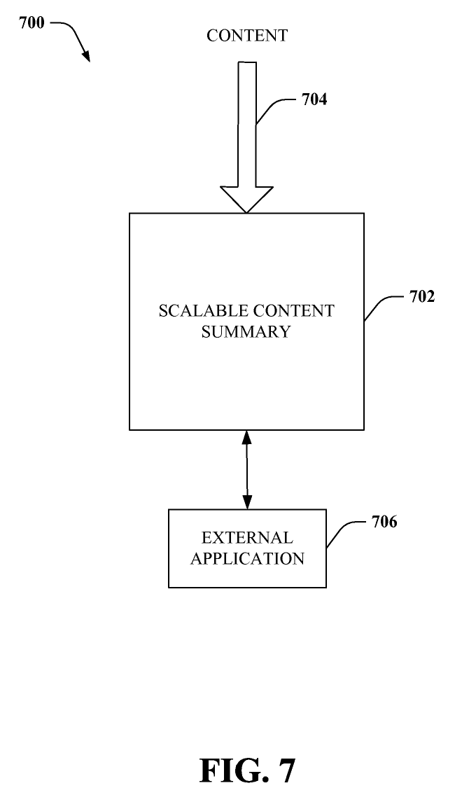

FIG. 7 depicts a system 700 illustrating an external application in conjunction with scalable summaries of content 704 in accord with aspects of the claimed subject matter. Scalable content summary 702 can include a system that provides a structured display of information associated with a particular segment of auditory, text, and/or visual content 704 in accordance with aspects of the subject disclosure specified supra. More specifically, scalable content summary 702 can receive content 704 containing at least verbal information related to speech, and parse such information and translate it into text. Translated portions of the text can be identified as representative and descriptive of aspects of content 704, for instance, based on a TFIDF score or adjusted TFIDF score associated with such portions (supra). A sorted list of TFIDF scores and associated portions of text can then be displayed according to a zoom threshold and a zoom factor (e.g., user-defined factor, or default factor, or both). Display of such information can be dynamically adjusted to present few terms of high descriptiveness, or many terms of high to low descriptiveness, or any suitable variation in between (e.g., from display of a single keyword to display of a full document associated with content 704).

Additionally, system 700 can enable an external application 706 to alter or provide information suitable for altering an organization, distribution and/or display of information by scalable content summary 702 in accord with additional aspects disclosed herein. External application can be a hardware and/or software application, for example, that can display text in accord with various requirements of such application. For instance, a classroom lecture application can require information to be presented to a student in a manner appropriate for review of a particular subject. Keywords and keyword TFIDF scores can be adjusted based on representation of, relatedness to, and/or affiliation with aspects of such application. According to a particular embodiment, the keyphrase relevance rank associated with one or more of a plurality of keywords generated by components of scalable content summary 702 can be modified based at least in part on a context relevant to the external application.

As an additional example, if a particular lecture is based upon a calculus class, terms identifying steps to model and calculate a solution for a calculus problem can be weighted higher by external application 706 than other terms, such as conversational terms. Such terms could then be part of a broad overview of a calculus lecture. As described, scalable content summary 702 can be scaled to focus in on lecture topics dealing with, for instance, setting up a problem, visualizing a problem, mathematical procedures for solving the problem, walking through a solution, methods of identifying and approaching a solution to similar problems, etc. It is to be appreciated that the preceding example is simply one particular aspect of the subject specification, and that other embodiments made known to one of skill in the art via the context provided by this example are also contemplated within the scope of the claimed subject matter.

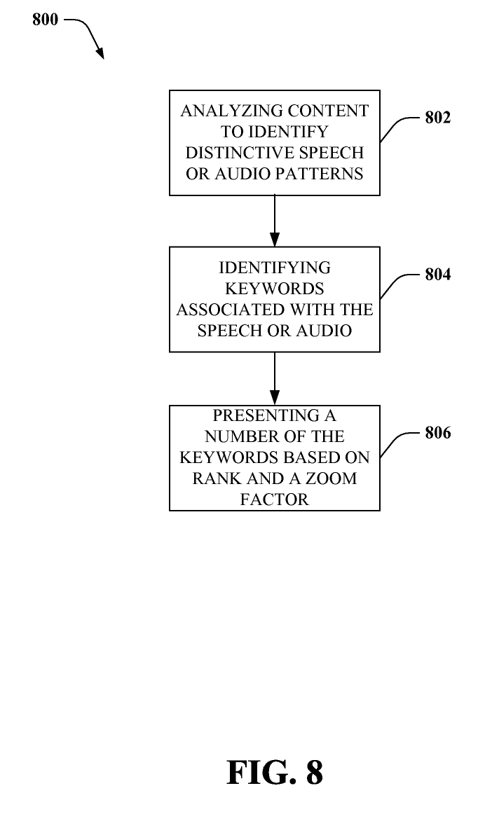

FIGS. 8-11 depict example methodologies in accord with various aspects of the claimed subject matter. For purposes of simplicity of explanation, the methodologies are depicted and described as a series of acts. It is to be understood and appreciated that the claimed subject matter is not limited by the acts illustrated and/or by the order of acts, for acts associated with the example methodologies can occur in different orders and/or concurrently with other acts not presented and described herein. For example, those skilled in the art will understand and appreciate that a methodology could alternatively be represented as a series of interrelated states or events, such as in a state diagram. Moreover, not all illustrated acts can be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 8 depicts a methodology for providing dynamically adjustable levels of information related to recorded or recordable content. At 802, content is analyzed to identify speech and/or similar audio patterns contained therein. The content can include any suitable audio and/or video content that contains or can be associated with speech, text, and/or a conversation associated with the content. Similar audio patterns can include discussion, machine-generate speech or other forms of artificial speech, text, and/or conversation that can identify portions of the content and provide commentary, discussion, explanation, etc. associated with such content. Analysis of content can be via any suitable mechanism for translation of audio, speech and/or voice related information into text or other distinguishable symbols.

At 804, a keyword is extracted from the speech or audio patterns, ranked with a relevance score, and associated with a portion of the content. The keyword can include one or more words, sounds, phrases, patterns, or the like, capable of representing and indicating portions of content and of being displayed and/or represented by text. Additionally, such keywords can be formed of one word or multiple words. The relevance score can be based, for instance, on a TFIDF score, or adjusted TFIDF score in a manner substantially similar to that described supra. A sorted list of keywords and keyphrase relevance ranks can be compiled and used for display of information associated with the content.

At 806, a number of keywords are presented based on the relevance score and a zoom factor. The zoom factor can be related to a keyword threshold and an amount of presentable space associated with a user interface. The keyword threshold can establish a cut-off for presenting or hiding keywords based on a relevance score associated with each keyword. The amount of presentable space can include graphical area available to render words on a display (e.g., amount of area on a display or monitor, in an application window, etc.). Additionally, the zoom factor can control a density, number, font size, etc., associated with the presentation of keywords. Changes in the zoom factor can increase and decrease a number of keywords displayed within a particular display area. Consequently, changing zoom factor values can lower and increase the keyword threshold, causing fewer or more keywords to be rendered, up to a number of keywords that will fit within an available presentation space. Optionally, quantities such as keyword font size, keyword spacing, presentable area size (e.g., for an application window or similar adjustable presentation area) and like factors can be adjusted, automatically or manually, to facilitate presentation of a scalable summary as described herein.

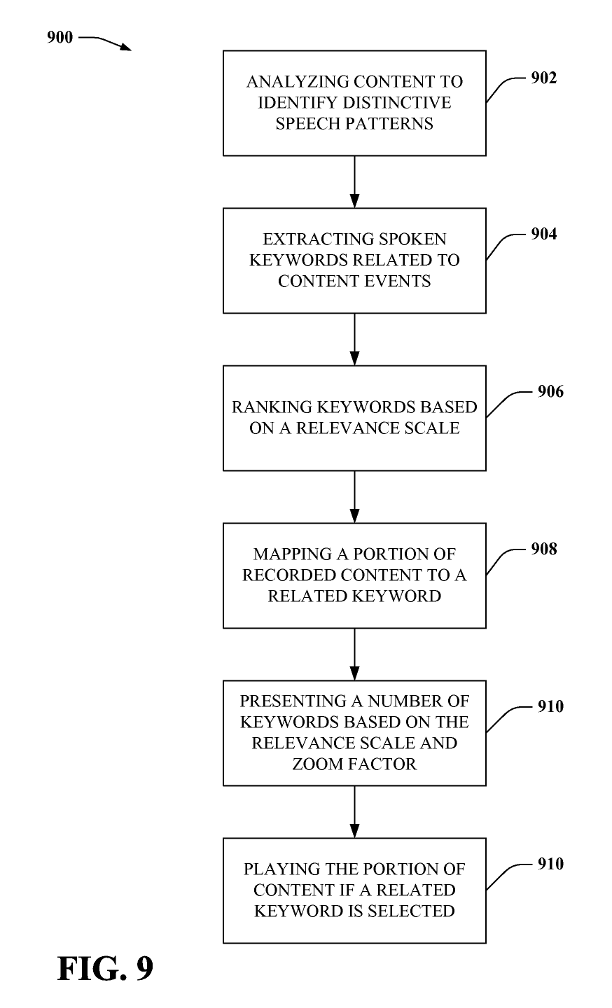

FIG. 9 depicts a sample methodology 900 for presenting scalable summaries of content in accord with aspects of the subject disclosure. At 902, content is analyzed to identify distinctive patterns of speech contained therein. Such speech can be in the form of a commentary (e.g., broadcast news), discussion (e.g., professional lecture), overview, etc., associated with some audio and/or video content. At 904, spoken keywords representative of portions of the content are extracted from the speech. Representation can be based on, for instance, a related topic of conversation, a related sequential segment of content, a turn of speaker, or like classifier associated with speech. At 906, keywords are ranked based on a relevance rank. The relevance rank(s) can indicate a likelihood of occurrence of a keyword and/or how representative a keyword is of a topic of discussion or other aspect of content. The relevance rank can be established at least in part on non-verbal cues (pitch, tone, loudness, and/or pauses of a speaker's voice), speaker turn information including a number of occurrences of a keyword in a speaker turn, visual cues, a TFIDF factor associated with a keyword, or combinations thereof.

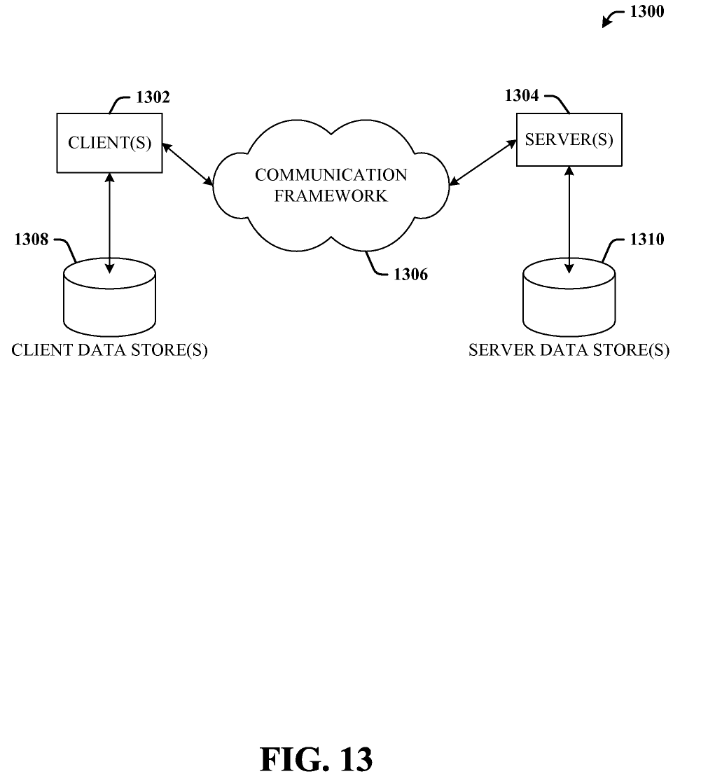

At 908, portions of recorded content are mapped to the keywords. Such mapping can, for example, allow the portions of recorded content to be accessed and/or played back by a user by selecting the keyword. As a more specific example, each keyword can be a link (e.g., hyperlink HTML link, XML link, and the like) to a local or remote data store containing the recorded content (see, for instance, FIG. 13 infra). Selecting the keyword can begin playback of the content at a point related to the keyword. For example, selection of a keyword can cause a recording to begin playing at a point in which the selected keyword occurs in the recording. At 910, a number of keywords are presented based on the relevance scale and a zoom factor. The zoom factor can be based, for instance, on an amount of graphical space available to render keywords, and a threshold level established by a user, or a default value. The zoom factor can be compared to the relevance scale associated with each keyword to determine whether a particular keyword is to be rendered or not. Consequently, by adjusting the zoom factor a user can increase and decrease a number of keywords presented, thereby transitioning from a broad overview to a detailed description of content in accord with aspects disclosed herein.

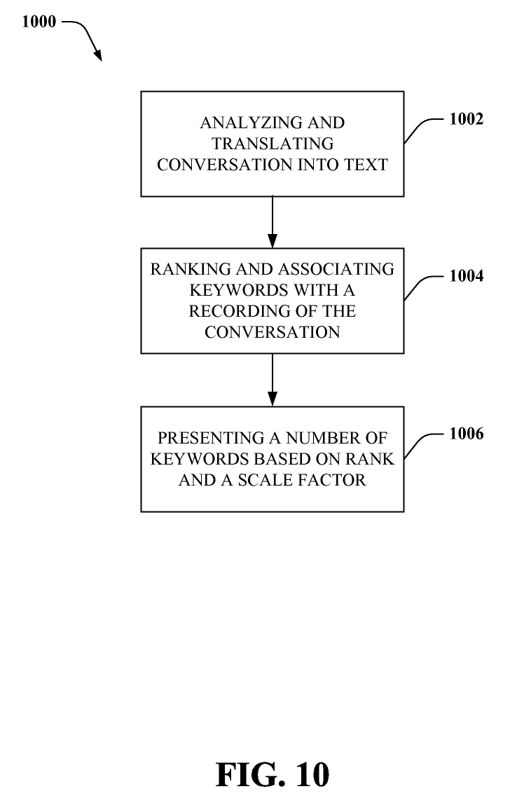

FIG. 10 illustrates a methodology for providing an adjustable summary associated with spoken conversations in accord with aspects of the claimed subject matter. At 1002, a spoken conversation is analyzed and translated into text. More specifically, the spoken conversation, as indicated herein, can be identified in one or more of various languages and can be translated to text in the same or substantially similar language, or into one or more different languages. Additionally, such text can be presented in a language according to one or more of various alphabets. Also, speech recognition can utilize typical methods for translating speech into text (e.g., similar to systems trained and/or calibrated on phone switchboard data). For example, a spoken conversation can be any suitable live, recorded, and/or distributed commentary, discussion, lecture, etc.

At 1004, keywords can be ranked and associated with portions of the recorded speech. Association in this manner can be based upon a topic of conversation, contiguous segments of a particular speaker speaking, based on a time sequence and occurrence of a keyword within a conversation, or like classifiers. Keywords can be ranked based on a TFIDF score, for example, in a manner substantially similar to that described supra. The ranking can identify an importance of a keyword in regard to how indicative such a keyword is of portions of the conversation. For example, keywords associated with a particular topic discussion, or that occur very frequently within a document can have a high keyword rank. At 1006, a number of keywords are presented based on keyword rank and a scale factor. The scale factor can further by dynamically adjusted to increase and decrease a number of keywords that provide a summary of a spoken conversation. More specifically, setting the scale factor can provide a brief overview of a conversation based on a few keywords, whereas the scale factor can be set to provide a highly descriptive review of portions of a conversation, or various degrees in between.

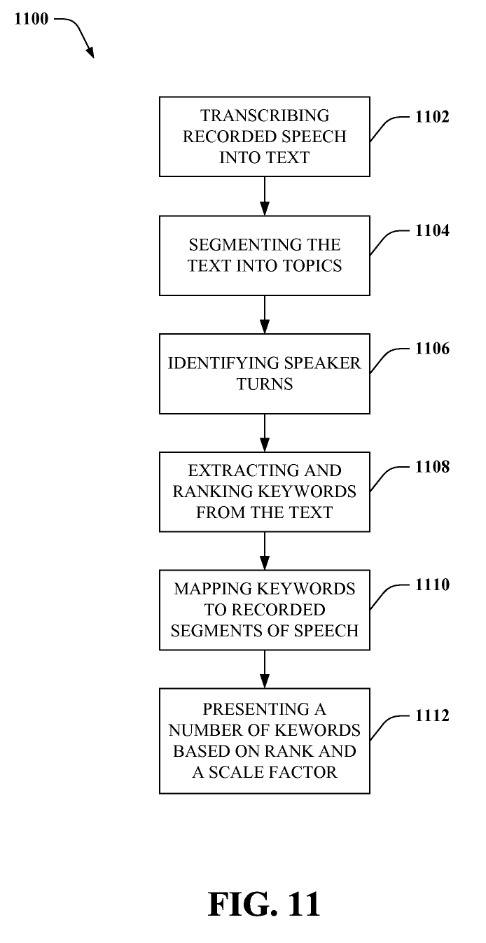

FIG. 11 illustrates a further exemplary methodology for presenting varying levels of detail in regard to a summary of a spoken conversation, in accord with aspects disclosed herein. At 1102, recorded speech is transcribed into text. Such speech recording can include a conversation between two or more individuals, for instance. At 1104, the translated text is segmented into topics. Such topic segmentation can be based a log-linear model for determining likelihood of transition from one topic boundary to another. For example, any point within a spoken conversation can be given a probability of being a topic boundary based on a log-linear model trained on a public corpus of Topic Detection and Tracking (TDT) data (e.g., a broadcast news corpus) using word distribution features and automatically selected keywords. Additional factors for identification of topic boundaries can occur through acoustic cues such as pauses in conversation or discussion, textual features within a conversation, etc. Furthermore, heuristic constraints can be utilized to remove content segments considered to short to be topic boundaries. Such a constraint can be established via a topic duration threshold, which can be constant, user-specified, or automatically determined.

At 1106, speaker turns are identified. Speaker turns can include a contiguous segment of a single speaker conversing. As speakers change or overlap, speaker turns can begin and end. At 1108, keywords are extracted from the translated text and associated with a relevance rank. Such relevance rank can indicate how representative the keyword is as related to a topic of discussion or to the conversation itself. Moreover, additional surrounding words can be associated with keywords to provide for additional context related to the keyword within a conversation. For example, a number of words previous and subsequent to a keyword can be associated with the keyword and displayed upon user request. Adding additional words to a keyword can help to indicate how a keyword is used within a conversation and a particular meaning associated with such use.

At 1110, keywords are mapped to recorded segments of the speech. Mapping can be used to access a particular portion of recorded spoken conversation by selecting a keyword. Such a mechanism enables a user to play back an original recording to extract additional information. Furthermore, as a recording plays, methodology 1110 can highlight, graphically distinguish, or otherwise indicate keywords that are relevant to concurrently played portions of the recording. For example, a horizontal indicator can jump to temporally displayed keywords as relevant portions of audio are played. At 1112, a number of keywords are presented based on the associated keyword rank and a scale factor. More specifically, presentation of a keyword or group of keywords can be established by comparing keyword rank(s) associated with such keyword(s) to a threshold. Additionally, a display of keywords can be as a function of identified topics, speaker turns, sequential occurrence with a conversation, or like classifier. Keywords grouped in such a manner can be graphically distinguished from other keyword groups. For example, a colored segment of display can indicate keywords associated with a particular topic, and a segment of display of a different color can indicate keywords associated with a second topic. Viewers can therefore scan an overview of keywords associated with one or more topics to quickly obtain basic information about a topic and a discussion related thereto. The number of keywords displayed can be specific to a particular classifier, or specific to an entire summary of the conversation. In such a manner, methodology 1100 provides for control over the level of detail of a summary or portions thereof, defined by topic, turn, and/or sequential boundaries.

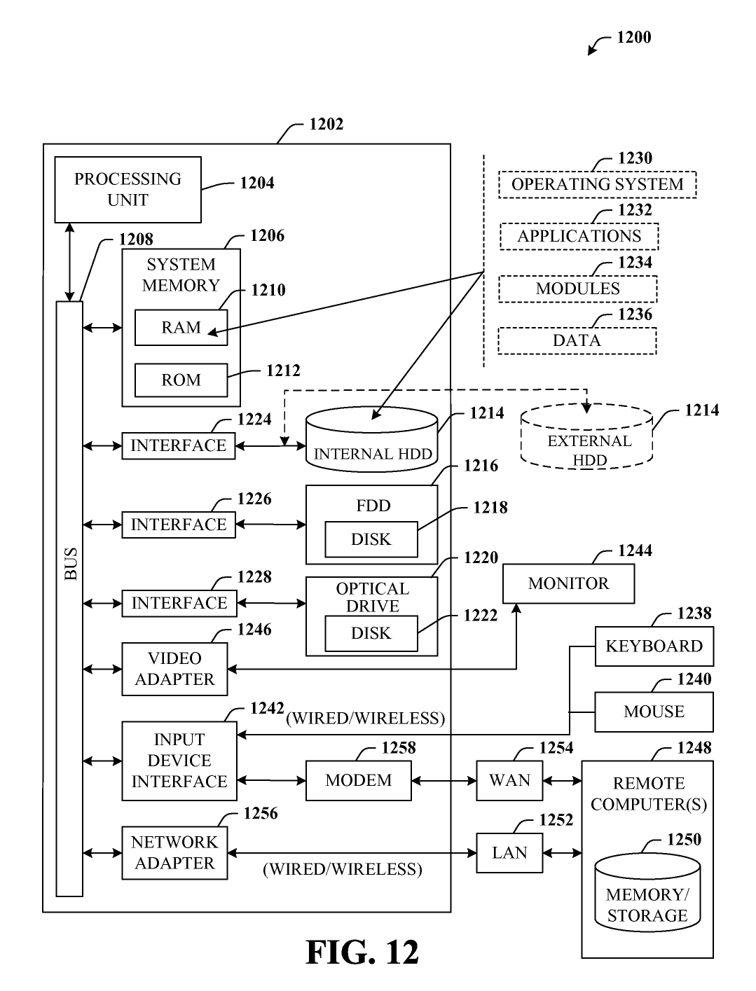

Referring now to FIG. 12, there is illustrated a block diagram of an exemplary computer system operable to execute the disclosed architecture. In order to provide additional context for various aspects of the subject invention, FIG. 12 and the following discussion are intended to provide a brief, general description of a suitable computing environment 1200 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the invention includes a computer 1202, the computer 1202 including a processing unit 1204, a system memory 1206 and a system bus 1208. The system bus 1208 couples to system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the invention can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9BaseT wired Ethernet networks used in many offices.

Referring now to FIG. 13, there is illustrated a schematic block diagram of an exemplary computer compilation system operable to execute the disclosed architecture. The system 1300 includes one or more client(s) 1302. The client(s) 1302 can be hardware and/or software (e.g., threads, processes, computing devices). The client(s) 1302 can house cookie(s) and/or associated contextual information by employing the invention, for example.

The system 1300 also includes one or more server(s) 1304. The server(s) 1304 can also be hardware and/or software (e.g., threads, processes, computing devices). The servers 1304 can house threads to perform transformations by employing the invention, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates review of content, comprising:
a browsing interface that receives text associated with or descriptive of audio or visual content, or both, or combinations thereof, and
a summarization component that extracts a plurality of keywords related to the received text, and creates a summarization hierarchy of the audio or visual content, or both, by presenting dynamically adjustable portions of the extracted keywords at the browsing interface.

2. The system of claim 1, further comprising a zoom component that adjusts the presentation of portions of the extracted keywords based on a keyphrase relevance rank and a zoom factor to reveal different levels of detail with respect to the audio or visual content, or both.

3. The system of claim 2, the zoom component displays multiple keywords as a function of an amount of graphical space associated with the zoom factor available to render keywords, and a number of keywords that fit within the graphical space in an order related to the keyphrase relevance rank.

4. The system of claim 1, comprising a temporal sequence component that structures display of one or more of the plurality of keywords according to a temporal occurrence of such keywords within the received text or the audio or visual content.

5. The system of claim 1 further comprising a playback component that plays portions of the audio or visual content, or both, based on selection of an associated keyword.

6. The system of claim 1, further comprising a topic segmentation component that identifies one or more topics within received text, and groups one or more of the plurality of keywords as a function of relationship to the one or more topics.

7. The system of claim 1, further comprising a context component that presents additional surrounding text for one or more of the plurality of keywords to provide context for the keywords.

8. The system of claim 1, further comprising a turn recognition component that groups text associated with the audio or visual content, or both, as a function of contiguous segments spoken by a single speaker.

9. The system of claim 1, further comprising an external application, the keyphrase relevance rank associated with one or more of the plurality of keywords is modified based at least in part on a context relevant to the external application.

10. The system of claim 2, the keyphrase relevance rank is based at least in part on non-verbal cues, speaker turn information, visual cues, TFIDF score, or textual context, or combinations thereof.

11. The system of claim 1, further comprising a speech recognition component, wherein at least a portion of the received text is translated from speech into text by the speech recognition component.

12. A method for providing scalable summaries of recorded content comprising:
analyzing content to identify speech or distinctive audio patterns, contained therein;
identifying one or more keywords associated with the speech or distinctive audio patterns; and
presenting at least one of the one or more keywords based on a relevance rank in relation to a scale factor.

13. The method of claim 12, further comprising extracting the keywords from the content based at least in part on relevance to events within the content.

14. The method of claim 12, further comprising mapping a portion of recorded content to the one or more related keywords.

15. The method of claim 14, further comprising playing the portion of recorded content if one or more of the related keywords mapped to the portion are selected, and graphically distinguishing keywords that are relevant to concurrently played portions of the recorded content.

16. The method of claim 12, the keyword rank is based at least in part on non-verbal cues, a TFIDF factor associated with the keyword, visual cues, speaker turn information including a number of speaker turns containing the keyword, or combinations thereof.

17. The method claim 12, further comprising segmenting the speech or distinctive audio patterns, or both, into one or more topics.

18. A system that facilitates review of audio or visual content, comprising:
means for visually representing portions of content with keywords related to translated speech, key-sounds associated with audio, or both; and
means for displaying a number of keywords representing portions of content based on a relevance rank associated with each of the number of keywords and a user-defined scale factor.

19. The system of claim 18, further comprising means for transcribing spoken words contained on storage media into text.

20. The system of claim 18, further comprising means for dynamically increasing or decreasing a display of keywords in response to increasing and decreasing the user-defined scale factor.
